(19) United States
(12) Patent Application Publication
(10) Pub. No.: US 2015/0040019 A1
(43) Pub. Date: Feb. 5, 2015

(54) METHOD AND APPARATUS FOR PROVIDING APPLICATION USER INTERFACE

(71) Applicant: ELECTRONICS AND TELECOMMUNICATIONS RESEARCH INSTITUTE, Daejeon (KR)

(72) Inventors: Bong Jin OH, Daejeon (KR); Jongyoul PARK, Daejeon (KR)

(73) Assignee: ELECTRONICS AND TELECOMMUNICATIONS RESEARCH INSTITUTE, Daejeon (KR)

(21) Appl. No.: 14/154,503

(22) Filed: Jan. 14, 2014

(30) Foreign Application Priority Data
Aug. 2, 2013 (KR) 10-2013-0092020

(51) Int. Cl. G06F 3/0484

(52) U.S. Cl. CPC G06F 3/0484
USPC 715/738

(57) ABSTRACT

The present invention relates to a method and apparatus for providing a terminal connected to a home network with an application UI that can be optimally displayed on the terminal. As a server terminal transmits a UI optimized for the graphics resolution of the client terminal to a client terminal, images and text can be sharply displayed on the UI for higher readability, and the speed of response to an event the client terminal's user enters on the application can be made faster. In addition, a client terminal user can have a pleasant user experience (UX).

### CROSS-REFERENCE TO RELATED APPLICATION

This application claims priority to and the benefit of Korean Patent Application No. 10-2013-0092020 filed in the Korean Intellectual Property Office on Aug. 2, 2013, the entire contents of which are incorporated herein by reference.

### BACKGROUND OF THE INVENTION

(a) Field of the Invention

The present invention relates to a method and apparatus for providing an application's execution screen that can be optimally displayed on a terminal in an internet-connected environment.

(b) Description of the Related Art

The technologies for managing multiple terminals connected together through a home network use a method to capture an image of a screen output on a particular terminal and transmit it, and allow a terminal that has received the image to magnify or reduce the image according to its graphics resolution. Alternatively, as is the case with game streaming, these technologies may use a method to encode a screen output on a particular terminal into video and transmit it as a video stream, and allow the terminal that has received the video stream to play the video stream according to its graphics resolution. These technologies may include the virtual network computing (VNC) protocol, the R-view (RVU) protocol, etc.

However, when capturing and transmitting an image of a screen, if the image is displayed in a reduced size because the terminal that has received the image has a low resolution, this may make the screen smaller or distort text displayed on the screen.

### SUMMARY OF THE INVENTION

The present invention has been made in an effort to provide a method and apparatus for providing a terminal connected to a home network with an application UI that can be optimally displayed on the terminal.

An exemplary embodiment of the present invention provides a method for providing a terminal connected to a home network with an application UI. The UI providing method may include: receiving a terminal's profile from the terminal; creating a window for the terminal based on the profile; outputting a UI to the window; and transmitting the output UI to the terminal.

The creating of a window may include: extracting the terminal's graphics resolution information from the profile; and creating a window based on the graphics resolution information.

The UI providing method may further include: receiving an event on the application from the terminal; and outputting a modified UI to the window in response to the event.

The transmitting of the output UI may include: capturing a portion corresponding to the window from a video memory included in the UI providing apparatus; and encoding the captured video memory portion.

Another exemplary embodiment of the present invention provides an apparatus for providing an application UI to a terminal connected to a home network. The UI providing apparatus may include: a remote UI unit that receives a terminal's profile from the terminal, creates a window for the terminal based on the profile, and outputs a UI to the window; and an application execution processor that executes the application and outputs the UI to the window.

The remote UI unit may extract the terminal's graphics resolution information from the profile and create a window based on the graphics resolution information.

The remote UI unit may deliver an event on the application received from the terminal to the application execution processor, and the application execution processor may output a modified UI to the window in response to the event to the window.

The remote UI unit may capture a portion corresponding to the window from a video memory included in the UI providing apparatus, and encode the captured video memory portion.

### BRIEF DESCRIPTION OF THE DRAWINGS

FIG. 1 is a view showing a home network according to an exemplary embodiment of the present invention.

FIG. 2 is a view showing a server terminal according to an exemplary embodiment of the present invention.

FIG. 3 is a flowchart showing a process for sending and receiving an application UI according to the exemplary embodiment of the present invention.

FIG. 4 is a view showing a UI according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. The terms such as “-unit”, “-ed-or”, “-module”, and “-block” stated in the specification may signify a unit to process at least one function or operation, and may be embodied by hardware, software, or a combination of hardware and software.

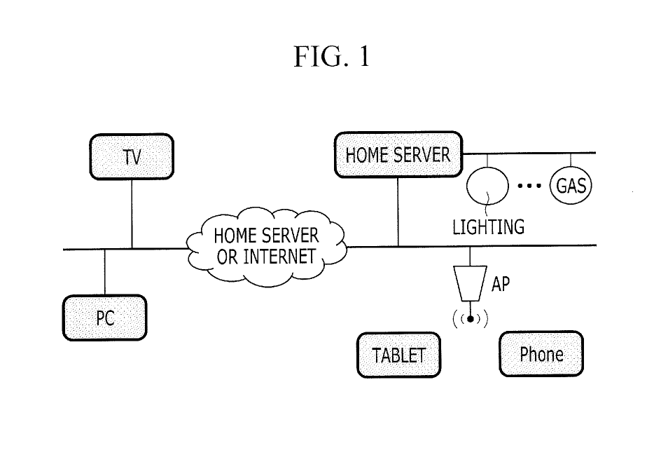

FIG. 1 is a view showing a home network according to an exemplary embodiment of the present invention.

The exemplary embodiment of the present invention will be described with respect to a home network, but the present invention is not limited thereto. Each terminal included in a home network operates as a server terminal when transmitting a user interface (UI) to other terminals, and operates as a client terminal when receiving a UI from other terminals.

Referring to FIG. 1, a PC, a TV, etc. may be connected to a home network according to an exemplary embodiment of the present invention through a local area network (LAN) or the Internet, facilities such as lighting or gas in a house may be connected to the home network through a home server, and wireless devices such as a mobile phone, a tablet, etc. may be connected to the home network through an access point (AP).

A server included in the home network according to the exemplary embodiment of the present invention may display an application UI, taking the profile of each terminal into account, in such a way that a UI for displaying an application is encoded into an image or video, as is the case with the VNC or RVU. That is, a terminal delivers profile information to a server terminal before connecting to the server terminal and receiving a UI, so that the server terminal can create an application UI customized to the client terminal and then transmit it.

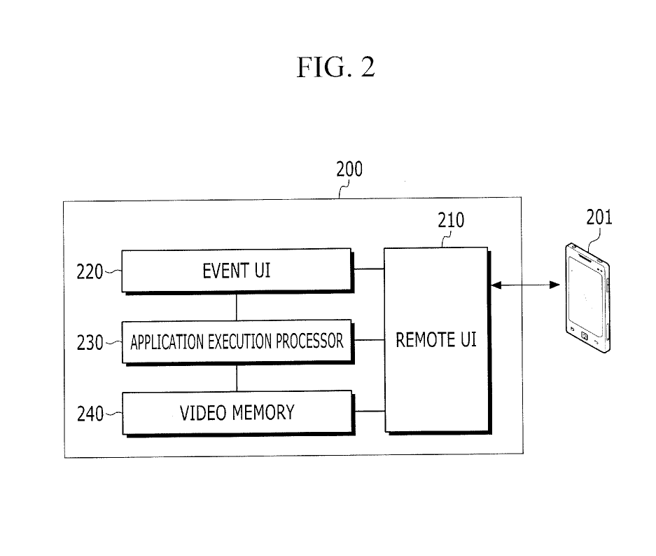

FIG. 2 is a view showing a server terminal according to an exemplary embodiment of the present invention.

Referring to FIG. 2, a terminal 200 according to an exemplary embodiment of the present invention includes a remote UI 210, an event UI 220, an application execution processor 230, and a video memory 240.

If the terminal 200 operates as a server terminal, the remote UI 210 may receive a profile from another terminal (i.e., client terminal) 201, to which an application UI will be transmitted, and transmit the application UI to the client terminal 201. Also, the remote UI 210 may encode the UI when transmitting the application UI to the client terminal 201.

If the terminal 200 operates as a client terminal, the remote UI 210 may transmit its profile to a server terminal, receive the encoded application UI from the server terminal, and decode the received UI.

The event UI 220 may transmit an event entered through various types of input devices to a server terminal if the terminal 200 operates as a client terminal, and may deliver the event received by the client terminal to the application execution processor 230 if the terminal 200 operates as a server terminal.

The application execution processor 230 may transmit an application UI to the video memory 240, upon receiving an instruction from the client terminal 201 or by independently executing the application. Meanwhile, the remote UI 210 directs the application execution processor 230 to create a window suited to the resolution of the client terminal 201 according to the profile of the client terminal 201 received from the client terminal 201. Accordingly, the application execution processor 230 can deliver the application UI suited to the resolution of the client terminal 201 to the video memory 240.

If the terminal 200 operates as a server terminal, the video memory 240 outputs the application UI transmitted from the application execution processor 230 to the previously created window, and captures a memory portion corresponding to the window and delivers it to the remote UI 210. On the other hand, if the terminal 200 operates as a client terminal, the application UI, decoded after it has been transmitted from the server terminal, is received and output to the window. That is, the user of the client terminal 201 can interface with the server terminal 200 through the application UI output to the window.

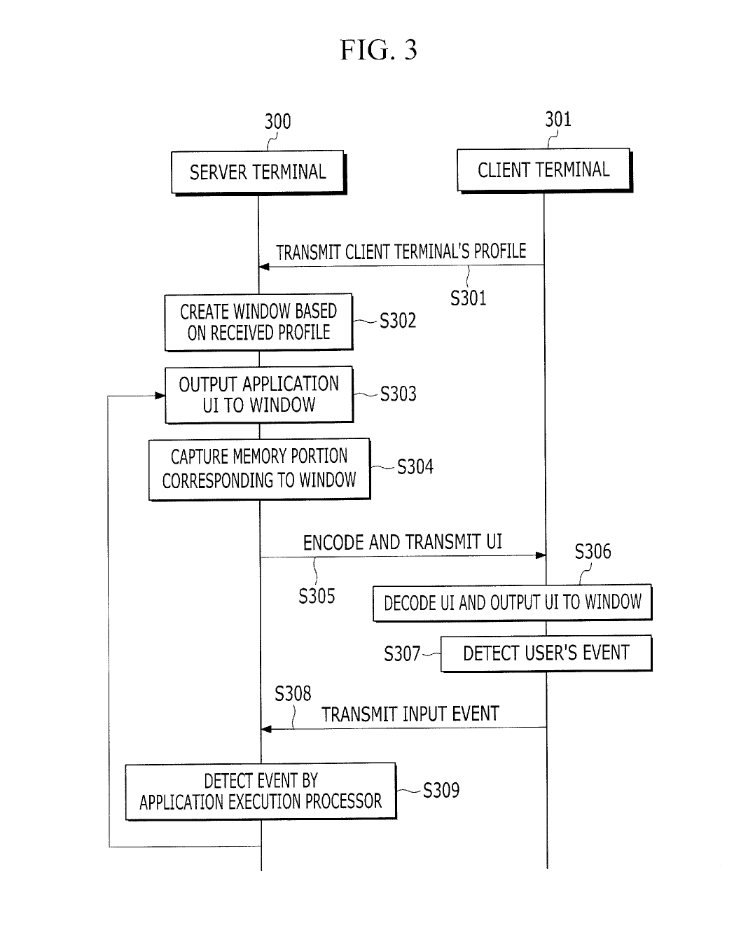

FIG. 3 is a flowchart showing a process for sending and receiving an application UI according to the exemplary embodiment of the present invention.

Referring to FIG. 3, a client terminal 301 transmits its profile to a server terminal 300 in order to receive an application UI from the server terminal 300, and the server terminal 300 receives the profile of the client terminal 301 (S301).

The server terminal 300 then creates a window where the application UI is to be displayed, based on the received profile of the client terminal 301 (S302). That is, graphics resolution information can be extracted from the profile of the client terminal 301, and the size of a window to be created can be determined according to the graphics resolution information.

Next, the server terminal 300 executes the application and outputs the application UI on the created window (S303). Then, the server terminal 300 captures a portion corresponding to the window from the video memory included in the server terminal 300, encodes it, and transmits the encoded portion to the client terminal 301. That is, the application UI output on the window is encoded and transmitted to the client terminal 301 (S304 and S305).

Having received the encoded application UI from the server terminal 300, the client terminal 301 decodes the encoded application UI and then outputs it on the window (S306).

As such, according to the exemplary embodiment of the present invention, the server terminal 300 can create an application UI according to the profile of the client terminal 301, and therefore the application UI transmitted from the client terminal 301 can be decoded and output to the window as it is, without having to be magnified or reduced in size.

The user can then enter a particular event through an input device upon seeing the application UI displayed on the client terminal 301, and the client terminal 301 detects the event (S307). The client terminal 301 transmits the user-input event to the server terminal 300 (S308).

Upon receiving the event from the client terminal 301, the server terminal 300 modifies the application UI in response to the event, and outputs the modified application UI to the window (S309).

According to the exemplary embodiment of the present invention, the position on the screen where the event has occurred can be accurately delivered from the client terminal 301 to the server terminal 300. As the server terminal 300 and the client terminal 301 share the same UI, the client terminal 301 can deliver the event as it is to the server terminal 300, without having to change the position on the screen where the event has occurred. As such, according to the exemplary embodiment of the present invention, the application can quickly respond to a user-input event.

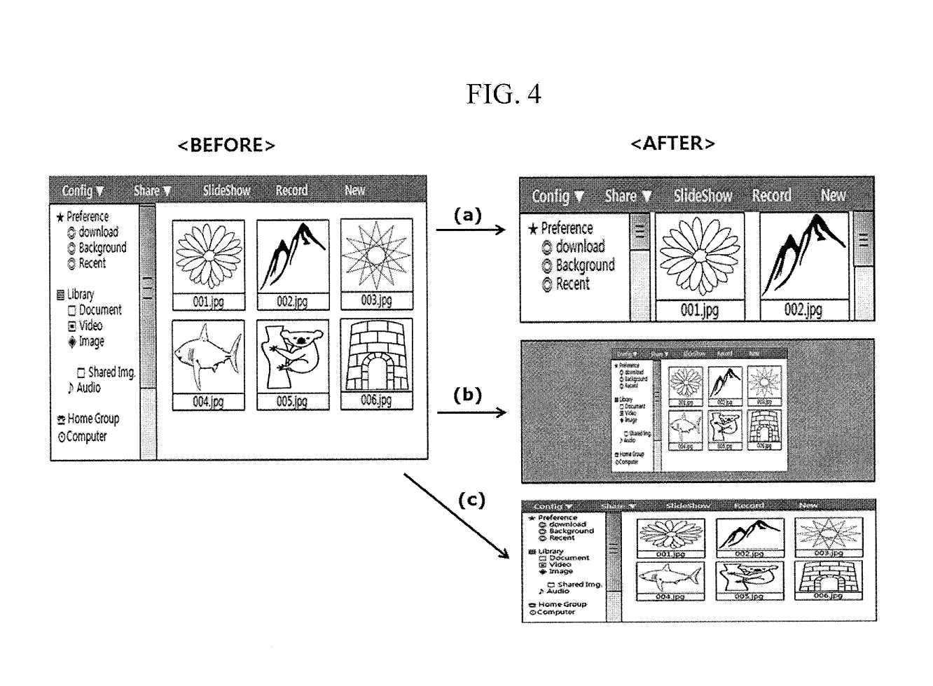

FIG. 4 is a view showing a UI according to the exemplary embodiment of the present invention.

Referring to FIG. 4, the application UI that can be displayed as shown in the left (“BEFORE”) may be modified as shown in the right (“AFTER”) according to the profile of the client terminal 201. In the conventional art, the UI is modified as the manner of (b) and (c), making the screen too small or distorting text for inputting events. However, the UI modified according to the exemplary embodiment of the present invention (route (a)) can be displayed as it is without text distortion by making the best use of the graphics resolution of the client terminal 201.

As seen above, as a server terminal according to the exemplary embodiment of the present invention transmits a UI optimized for the graphics resolution of a client terminal to the client terminal, images and text can be sharply displayed on the UI for higher readability, and the speed of response to an event the client terminal's user enters on the application can be made faster. In addition, a terminal user can have a pleasant user experience (UX).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a terminal connected to a home network with an application UI, the method comprising:
receiving a terminal's profile from the terminal;
creating a window corresponding to the terminal based on the profile;
outputting a UI to the window; and
transmitting the output UI to the terminal.

2. The method of claim 1, wherein
the creating of a window comprises:
extracting the terminal's graphics resolution information from the profile; and
creating a window based on the graphics resolution information.

3. The method of claim 1, further comprising:
receiving an event on the application from the terminal; and
outputting a modified UI to the window in response to the event.

4. The method of claim 1, wherein
the transmitting of the output UI comprises:
capturing a portion corresponding to the window from a video memory included in the UI providing apparatus; and
encoding the captured video memory portion.

5. An apparatus for providing an application UI to a terminal connected to a home network, the apparatus comprising:
a remote UI unit that receives a terminal's profile from the terminal, creates a window for the terminal based on the profile, and outputs a UI to the window; and
an application execution processor that executes the application and outputs the UI to the window.

6. The apparatus of claim 5, wherein the remote UI unit extracts the terminal's graphics resolution information from the profile and creates a window based on the graphics resolution information.

7. The apparatus of claim 5, wherein
the remote UI unit delivers an event on the application received from the terminal to the application execution processor, and
the application execution processor outputs a modified UI to the window in response to the event to the window.

8. The apparatus of claim 5, wherein the remote UI unit captures a portion corresponding to the window from a video memory included in the UI providing apparatus and encodes the captured video memory portion.
